(19) United States
(12) Patent Application Publication
(10) Pub. No.: US 2010/0032584 A1
(43) Pub. Date: Feb. 11, 2010

(54) TIIME GATED FLUORESCENT FLOW CYTOMETER

(75) Inventors: Jin Dayong, New South Wales (AU); Jim Piper, Lane Cove (AU); Russell Connally, Marsfield (AU)

Correspondence Address: ARENT FOX LLP, 1050 CONNECTICUT AVENUE, N.W., SUITE 400, WASHINGTON, DC, 20036, US

(73) Assignee: MACQUARIE UNIVERSITY, North Ryde, New South Wales (AU)

(21) Appl. No.: 12/377,066

(22) PCT Filed: Aug. 17, 2007
(86) PCT No.: PCT/AU07/01168

§ 371 Date: Sep. 30, 2009

(30) Foreign Application Priority Data
Aug. 18, 2006 (AU) 2006904525

(51) Int. Cl. G01N 21/64; G01J 1/58

(52) U.S. Cl. 250/459.1; 250/458.1; 250/461.1; 250/552; 356/51; 977/773

(57) ABSTRACT

An apparatus (10) for detecting a particle (12) labelled with a fluorescent marker is disclosed. The apparatus (10) has a flow cell (16) being adapted to contain a fluid (14) in which the particle (12) is suspended. A light source (28) is operatively coupled to the flow cell (16) and arranged for emitting a stimulating light (28) which is effective in optically exciting the fluorescent marker (12) for emitting a fluorescent light (30). The apparatus (10) also includes a spatial filter (50) across an optical path between the particle (12) and a time gated detector (32) operatively coupled to the flow cell (16) for detecting the fluorescent light (30).

### FIELD OF THE INVENTION

The invention relates broadly to an apparatus for detecting a particle labelled with a fluorescent marker, the particle being suspended in a fluid.

### BACKGROUND OF THE INVENTION

Flow cytometry is a technique to quickly count and sort cells, biomolecules, viruses, cells, protozoa, bacteria, micro particles or other particles suspended in a fluid. The fluid containing the particles is passed through a flow cell through which a beam of light, typically a laser beam, passes. In one embodiment of flow cytometry the laser light is scattered by a particle in the flow cell and the scattered light is detected. The number of particles that have passed through the flow cell can thus be counted, sized and sorted. In another embodiment, the particles are first labelled with a fluorescent marker. A beam of light excites the fluorescent marker and the resulting fluorescent light is detected for counting of the particles. Flow cytometry finds numerous applications including cell biology, chromosome analysis, particle sorting, immunology, haematology and microbiology.

Flow cytometry is a particularly powerful means for the quantitative detection of biomolecules. Fluorescence techniques can provide exquisite sensitivity, however fluorescent markers can lose much of their discriminatory power when viewed in the presence of autofluorescence. Organic and inorganic autofluorophores are in nature and some materials fluoresce with great intensity, diminishing the visibility of fluorescent markers. Spectral selection techniques are useful in suppressing these unwanted sources of interference but by themselves are not always sufficient because of the abundance and spectral range of autofluorophores. Fluorescent markers with long fluorescence lifetimes in conjunction with time gated detection can overcome these problems. Lanthanide (including Eu⁺⁺ or Tb⁺⁺) chelate fluorescent markers have exceptionally long fluorescence lifetimes reaching milliseconds in some compounds, which is much longer than the fluorescence lifetime of autofluorophores. The very large difference in lifetimes is conveniently exploited by detecting the long lived fluorescence after the autofluorescence in the sample has decayed away. In some circumstances, platinum or palladium porphyrin fluorescent markers can be used instead of lanthanide chelate fluorescent markers. Time gated flow cytometry is designed to capture only long lived fluorescence emission after autofluorescence has decayed away.

Less than 1% of microorganisms found in the environment respond to culture and the detection of rare organisms using conventional fluorescent techniques can be exceptionally difficult. Time gated techniques are particularly advantageous in the detection of rare events since the method results in a high contrast labelled target against a near void background, greatly increasing the likelihood of detection. Thus, the ultra sensitive in situ detection of, for example, water-borne pathogens such as Cryptosporidium and Giardia within highly autofluorescent environments becomes possible.

Early on researchers employed chopper wheels in combination with cw lasers as inexpensive pulsed excitation sources. However, choppers have an inflexible pulse regime, waste light and potentially give image blur arising from drive motor vibration. Nitrogen lasers have found favour as a pulsed excitation source since they emit powerful nanosecond pulses in the ultraviolet (337 nm) and are relatively inexpensive. However the low repetition rate of N₂ lasers (10-60 Hz) is a significant detraction and their rapid high voltage discharge radiates an intense electromagnetic pulse that can cause instrumentation problems. Helium cadmium (HeCd) lasers are continuous wave sources of ultraviolet light that can be acousto-optically modulated to generate the required short ultraviolet light pulses for lanthanide chelate time resolved optical fluorescence flow cytometry. Although their capital cost is intermediate, these laser sources are very inefficient and the modulator adds further to the costs. Gas discharge lasers require substantial electrical power input and generate significant heat that must be dissipated. Furthermore, the acousto-optic modulator requires a high voltage radio frequency drive signal and only a small portion of the input laser beam is modulated and available for sample excitation. Gas discharge laser excitation systems are bulky, expensive and relatively unreliable.

A low cost flow cytometer for CD4/CD8 monitoring is highly desirable in Africa and other resource poor nations. To monitor disease progression in HIV/AIDS patients, absolute CD4+ and CD8+ T cell counts are typically required to be tested every 3 months for every patient, however, due to the operational cost and complexity of regular flow cytometry testing of blood, only 0.25% of HIV infected patients, in South Africa for example, are tested according to a recent report.

### SUMMARY OF THE INVENTION

According to one aspect of the invention there is provided an apparatus for detecting a particle labelled with a fluorescent marker, the apparatus comprising:
a flow cell being adapted to contain a fluid in which the particle is suspended;
a light source operatively coupled to the flow cell and arranged for emitting a stimulating light which is effective in optically exciting the fluorescent marker for emitting a fluorescent light; and
a spatial filter positioned across an optical path between the particle and a time gated detector operatively coupled to the flow cell for detecting the fluorescent light.

Preferably the light source is a light emitting diode.

Preferably the apparatus includes a condenser lens for collecting the stimulating light. More preferably the apparatus includes another spatial filter for spatially filtering the stimulating light. Still more preferably the apparatus includes a wavelength selective filter for filtering the stimulating light. Yet still more preferably the apparatus includes a dichroic mirror for reflecting the stimulating light. Even still more preferably the apparatus includes an objective lens for focussing the stimulating light.

Preferably the apparatus includes an objective lens for collecting the fluorescent light. More preferably the spatial filter is at an image plane of the objective lens for collecting the fluorescent light. Even more preferably the detector is an optical band limited detector. Still more preferably the optical band limited detector includes an optical pass band filter for passing the fluorescent light.

According to another aspect of the invention there is provided an apparatus for detecting a particle labelled with a fluorescent marker, the apparatus comprising:
a flow cell being adapted to contain a fluid in which the particle is suspended;
a light source operatively coupled to the flow cell and arranged for emitting a stimulating light which is effective in optically exciting the fluorescent marker for emitting a fluorescent light;
an object of interest detector operatively coupled to the cell and adapted to trigger the light source; and
a time gated detector operatively coupled to the flow cell for detecting the fluorescent light.

Preferably the object of interest detector is an optoelectronic object of interest detector. More preferably the object of interest detector includes a probe light and a scattered light detector, the probe light being arranged to interact with the object of interest creating a scattered probe light, and a scattered light detector being arranged to detect the scattered probe light for triggering a pulse from the light source. Even more preferably the scattered light detector is a forward scattered light detector. Alternatively, the scatted light detector is a side scattered light detector.

According to yet another aspect of the invention there is provided a method of detecting a particle labelled with a fluorescent marker, the method comprising the steps of:
passing a fluid in which the particle is suspended through an interaction zone of a flow cell;
optically exciting the fluorescent marker by periodically illuminating the interaction zone with pulses of stimulating light with the time interval between pulses being less than the time for the particle to cross the interaction zone; and
time gated detection of a fluorescent light emitted from the optically excited fluorescent marker.

According to still yet another aspect of the invention there is provided an apparatus for detecting a particle labelled with a fluorescent marker, the apparatus comprising:
a flow cell being adapted to contain a fluid in which the particle is suspended;
a light emitting diode operatively coupled to the flow cell and arranged for emitting a stimulating light which is effective in optically exciting the fluorescent marker for emitting a fluorescent light; and
a time gated detector operatively coupled to the flow cell for detecting the fluorescent light.

Preferably the light emitting diode is an ultraviolet light emitting diode. More preferably the ultraviolet light emitting diode is one of a plurality of ultraviolet light emitting diodes. Even more preferably the light emitting diode is a laser diode.

Preferably the light emitting diode is a pulsed light emitting diode.

Preferably the light emitting diode is driven by a pulsed light emitting diode current for pulsing the stimulating light.

Preferably the time gated detector is an electronically time gated detector. More preferably the time gated detector is a solid state channel photomultiplier tube.

Preferably the apparatus includes a current-voltage amplifier for receiving a current from the time gated detector. More preferably the apparatus includes a data acquisition circuit for receiving a voltage from the current-voltage amplifier. Still more preferably the apparatus includes electronics for receiving data from the data acquisition circuit.

According to even still yet another aspect of the invention there is provided a method of detecting a particle labelled with a fluorescent marker, the method comprising the steps of:
passing a fluid in which the particle is suspended through a flow cell;
optically exciting the fluorescent marker with a stimulating light from a light emitting diode for emission of a fluorescent light; and
time gated detection of the fluorescent light.

Preferably the method also comprises the step of emitting the stimulating light as a pulse of stimulating light.

Preferably the step of time gated detection involves the step of synchronising the time gated detection with the step of emitting a pulse of stimulating light. More preferably the step of synchronising the time gated detection with the step of emitting a pulse of stimulating light involves opening the gated detector after the step of emitting the pulse of stimulating light. Still more preferably the step of time gated detection of the fluorescent light involves the step of collecting the fluorescent light. Even more preferably the step of time gated detection of the fluorescent light includes the step of filtering the fluorescent light. Even still more preferably the step of time gated detection of the fluorescent light includes the step of limiting the coverage of the detector with respect to the flow cell.

Preferably the step of optically exciting the fluorescent marker with a stimulating light includes the step of collecting the light from the light emitting diode. 1

Preferably the step of optically exciting the fluorescent marker with stimulating light includes the step of filtering the stimulating light. More preferably the step of optically exciting the fluorescent marker with the stimulating light includes the step of focusing the stimulating light.

Preferably the step of emitting a pulse of stimulating light is triggered when an object-of-interest is detected.

Preferably the fluorescent marker has a fluorescence lifetime greater than 100 nanoseconds.

According to yet even still another aspect of the invention there is provided a method of detecting a particle, the method comprising the steps of:
labelling the particle with a nanoencapsulated fluorescent marker;
passing a fluid in which the particle is suspended through a flow cell;
optically exciting the fluorescent marker with stimulating light from a light emitting diode for emission of a fluorescent light; and
time gated detection of the fluorescent light.

Preferably the step of labelling the particle includes labelling the particle with an nanoencapsulated oxygen-quenchable dye or complex. More preferably the step of labelling the particle include labelling the particle with nanoencapsulated platinum, ruthenium, osmium or rhenium dye or complex.

Preferably the step of optically exciting the fluorescent marker with stimulating light includes the step of generating blue and/or violet light from a light emitting diode. More preferably the step of generating blue and/or violet light includes the step of pulsing the light emitting diode. Even more preferably the light emitting diode is a laser light emitting diode.

### BRIEF DESCRIPTION OF THE FIGURES

In order to achieve a better understanding of the nature of the invention a preferred embodiment of an apparatus for detecting a particle labelled with a fluorescent marker and a method of detecting the particle will now be described, by way of example only, with reference to the accompanying figures in which:

FIG. 1 shows a schematic diagram of one embodiment of the invention;

FIG. 2 shows one embodiment of a flow cell of the invention;

FIG. 3 is one embodiment of a drive circuit of the invention;

FIG. 4 shows the use of multiple light emitting diodes in another embodiment of the invention;

FIG. 5 is another embodiment of the invention including an object-of-interest detector;

FIG. 6 shows a schematic of yet another embodiment of the invention; and

FIG. 7 shows a relationship between a UV pulse train and a gated detection.

### DETAILED DESCRIPTION OF THE INVENTION

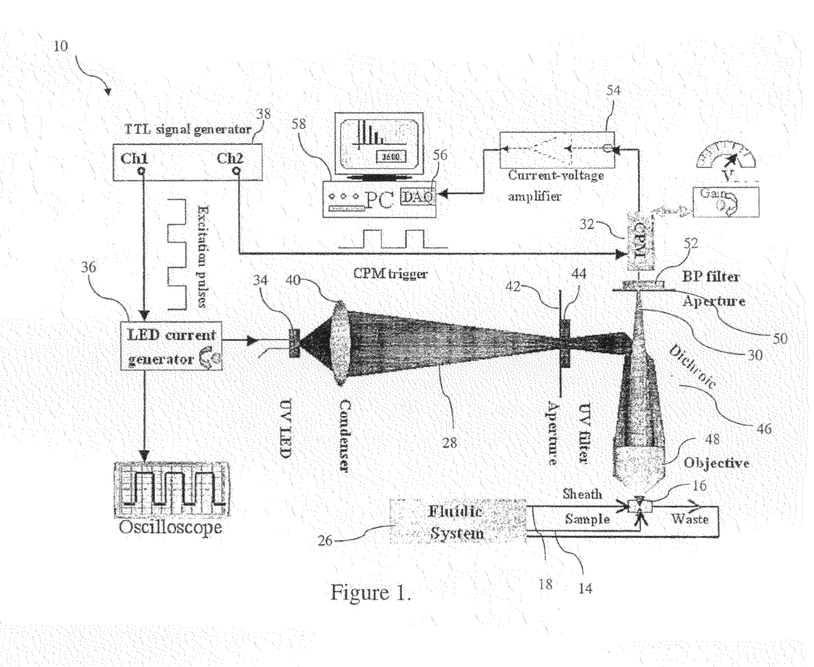

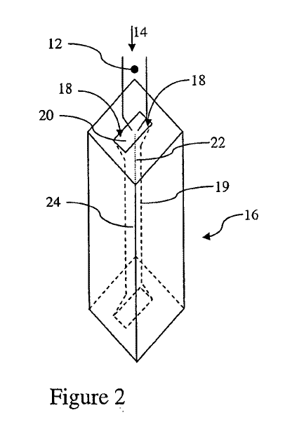

FIG. 1 depicts one embodiment of an apparatus 10 for detecting a particle labelled with a fluorescent marker. As shown in FIG. 2, the particle 12 is suspended in a sample fluid 14 that is injected into a capillary 19 of a flow cell 16 for interrogation. A sheath fluid 18 is simultaneously injected into the capillary 19, in an annular region 20 around the injected sample fluid 14. The small diameter of the capillary 19 ensures that the sheath fluid 18 flow is laminar. The sheath fluid 18 hydrodynamically focuses the sample fluid 14 into a thin fluid channel 22 along the axis of the capillary 19 lining up the particle 12. In this embodiment, the flow cell 16 is made of an ultraviolet transparent optical material such as quartz. The capillary 19 has an internal cross section of 430 micrometres by 180 micrometres. The flow of the sample 14 and sheath 18 fluids is promoted by a fluid vacuum pump 26. In this embodiment, the fluid flow is 15.6 millilitres per minute and 166 microlitres per minute for the sheath 18 and sample 14 fluids respectively. The velocity of the fluids 14 and 18 through the capillary 19 is 3.3 metres per second. It will be appreciated that these parameters are not critical to the working of this embodiment of the invention.

The particles such as 12 flow into an interaction zone 24 located near the mid point of the thin fluid channel 22 in the flow cell 16 for detection. As depicted in FIG. 1, the fluorescently labelled particle 12 within the interaction zone 24 of the flow cell 16 is detected by time gated fluorescent detection. The fluorescent marker is optically excited by a modulated stimulating light 28, and the fluorescent light 30 emitted by the label is measured using a time gated detector 32. In this embodiment the modulated stimulating light 28 is a pulsed stimulating light. The time gated detector 32 is opened after the pulse of stimulating light 28 and after the decay of any autofluorescence of the sample or apparatus.

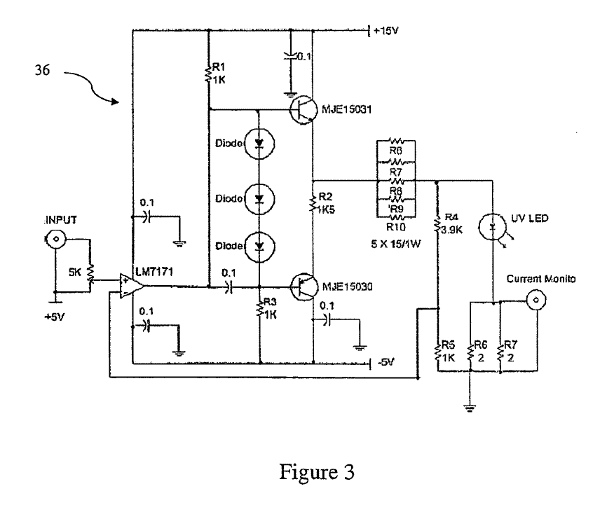

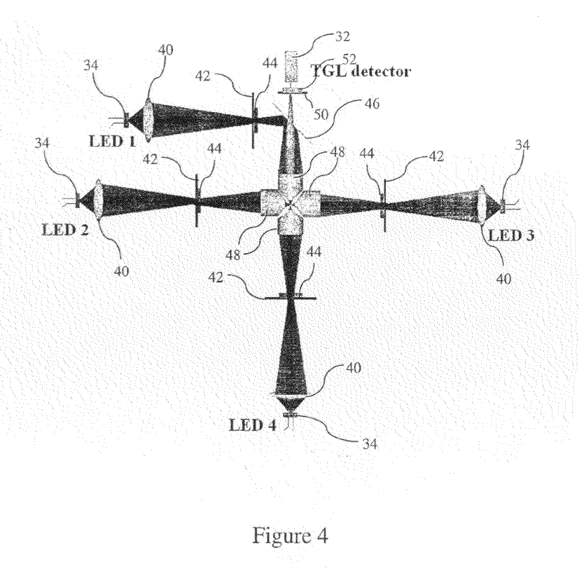

In this embodiment the stimulating light 28 is an ultraviolet light, with a spectrum spanning from 360 nanometres to 370 nanometres. It will be understood, however, that ultraviolet light from 300 nanometres to 370 nanometres could be used. This light is effective in optically exciting the Europium chelate fluorescent marker that labels the particle, although it will be understood that other lanthanide chelates or other fluorophores, such as palladium or platinum porphyrin, would also prove effective. The stimulating ultraviolet light 28 is emitted by a light emitting diode 34 of optical power 100 milliwatts. The peak ultraviolet light 28 power at the interaction zone 24 is 7.07 mW spread over an elliptical area of 0.53 mm². The peak power is achieved when 1.2 Amps is injected into the light emitting diode 34. The use of a light emitting diode 34 as the source of the stimulating light 28 is highly desirable because light emitting diodes are cheap, compact, efficient and reliable. The light emitting diode 34 is pulsed using a custom circuit 36 supplying a modulated light emitting diode current triggered by a channel of a TTL signal generator 38. The custom circuit diagram is shown in FIG. 3. As shown in FIG. 4, the stimulating light 28 can originate from more than one light emitting diode 34 for increased excitation of the fluorescent marker. It will be appreciated that another source of stimulating light, such as a lamp, laser diode, solid state laser or gas laser could be used instead of the light emitting diode.

In another embodiment of the invention, the particle 12 is labelled with a nanoencapsulated fluorescent marker. The nanoencapsulation enables the use of dyes and complexes, of for example, phosphorus, ruthenium, rhenium, osmium, or platinum, which would otherwise be quenched by, for example, oxygen. The nanoencapsulant may comprise silica or Polyacrylonitrile (PAN). These biomarkers have lifetimes that are sympathetic to the time for the particle 12 to cross an interaction zone 24, typically from 0.1 to 10 microseconds, which maximises the detected fluorescence and signal. The nanoparticles may be conjugated with antibodies for immunofluorescent labelling of target cells.

Encapsulated ruthenium complexes and dyes with a lifetime of around 6 microseconds, are particularly well suited to some applications, for example the detection of Giardia and E. Coli O157:H7. Their use necessitates less sample preparation. These markers may be excited by a blue and/or violet light pulse from, for example, a 445 nm and 50 mw laser light emitting diode (200 mw peak power when pulsed) manufactured by Nichia, Japan. Ideally the light pulses are 0.6 to 2.4 microseconds.

After the stimulating light 28 is collected from the light emitting diode 34 by a condenser lens 40, the stimulating light 28 passes through a spatial filter 42 and an optical filter 44. The filter 44 greatly reduce a long lived visible luminescence from the light emitting diode 34 extending from 470 nanometres to 750 nanometres. Without the filter 44 the visible luminescence increases the background noise level and reduces the signal to noise performance of the instrument. A dichroic mirror 46 turns the stimulating light 28 into an objective lens 48, the objective lens 48 focusing the stimulating light 28 into the interaction zone 24 within the flow cell 16. The particle 12 in the interaction zone 24 is optically excited by the focused stimulating light 28.

The fluorescent light 30 emitted by the particle 12 labelled with a fluorescent marker is collected by an objective lens 48, which in this embodiment, is the objective lens 48 used to focus the stimulating light 28. The fluorescent light 30 then passes through the dichroic mirror 46 to be filtered by optical filters 52 to stop any residual long lived visible luminescence emitted by the light emitting diode 34 before it reaches the time gated detector 32. The spatial filter 50, in this case an optical aperture, is placed in the plane in which the flow cell is imaged. The aperture limits the coverage of the detector 32 with respect to the flow cell 16. It will be appreciated that this enables the resolution of two closely spaced apart particles by obscuring only one of them from the detector, allowing an increase in the particle rate. It will be further appreciated that this is beneficial when detecting the particles tagged with a long-lifetime fluorescent marker. The imaged fluorescence creates a streak in the image plane during the period in which the gated detector is open. The aperture allows only a subsection of a streak to be detected, allowing an increase in the particle rate. It will be appreciated however that in the case of the short fluorescent lifetimes of nanoencapsulated dyes and complexes the aperture may be removed. An aperture placed at or near the object plane of the objective lens 48 would have a similarly beneficial effect as an aperture placed in the image plane of the objective lens 48.

The fluorescent light 30 is then incident onto the time gated detector 32, which in this embodiment is a solid state channel photomultiplier. The time gated detector 32 gain in this embodiment is ˜2×10⁶ V/A. The photo multiplier 32 was electronically gated by a second channel of the TTL signal generator 38. The TTL channels are synchronised. In this embodiment the channels have the same period and have a fixed phase relationship.

A current-voltage amplifier 54 receives a current from the time gated detector 32 and the output signal is passed to a data acquisition circuit 56 to convert the signal into a digital form for analysis. In this example the data acquisition circuit 56 is a data acquisition card connected to a programmable computer 58, although it will be understood that the programmable computer 58 could be replaced by an electronic circuit.

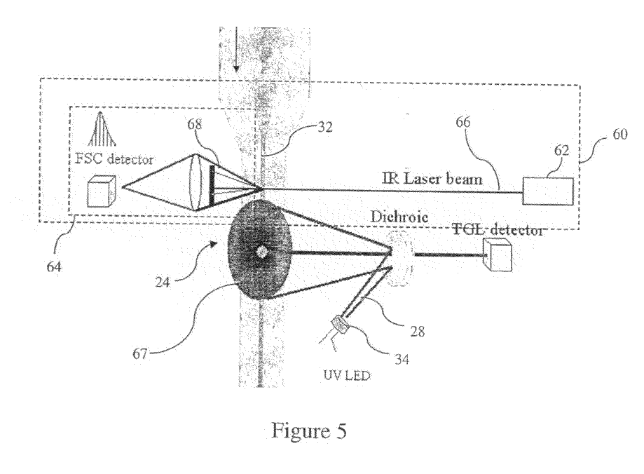

FIG. 5 depicts another embodiment of the invention. This embodiment includes an object-of-interest detector 60 composed of optoelectronic components including an infrared laser 62 and scattered light detector 64. The laser 62 emits a laser beam or probe light 66 that scatters off an object 67 in the thin fluid channel 32, when the object 67 approaches the interaction zone 24. The scattered light detector 64 is adapted to detect scattered light 68, the probe light 66 being scattered only when the object 67 is of a size similar to a particle 12 labelled with a fluorescent marker. On detection of scattered light 68 the scattered light detector 64 triggers the light emitting diode 34 (or other pulsed stimulating light source) to emit a pulse of stimulating light 28 just as the object 67 enters the interaction zone 24, thus maximising the likelihood of the particle being exposed to the stimulating light 28 as it travels through the interaction zone 24. The scattered light 68 in FIG. 5 is forward scattered light but it will be appreciated that it may be desirable to detect a side scattered light because side scattered light is sensitive to the particles shape, surface and internal structures.

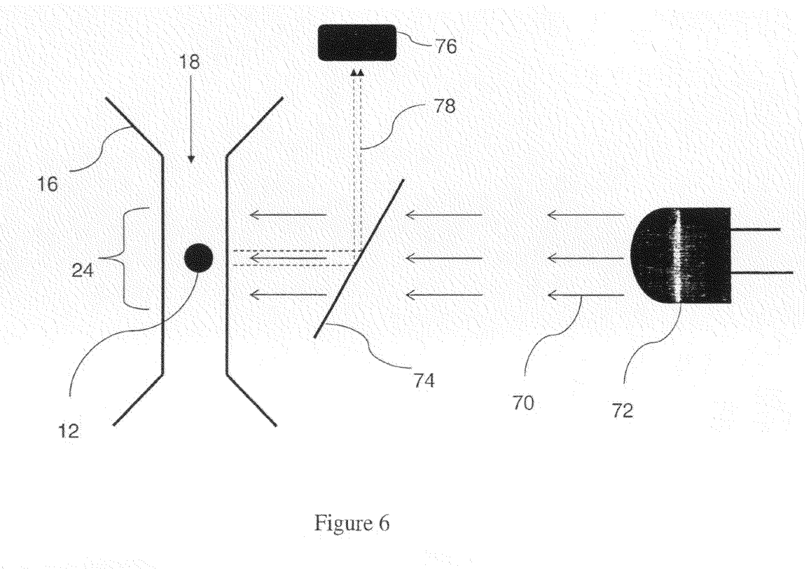

FIG. 6 depicts one embodiment of another aspect of the invention, which is a method of detecting a particle 12 labelled with a fluorescent marker. The sample fluid 18, in which the particle 12 is suspended, injects the particle 12 into the interaction zone 24 of a flow cell 16. Pulses of stimulating light 70 from a light emitting diode 72 (or other pulsed stimulating light source) optically excite the fluorescent marker. The time interval between the optical pulses of the stimulating light 70 is less than the time for the particle 12 to cross the interaction zone 24, ensuring that every particle such as 12 is excited. If the time interval between the optical pulses of stimulating light 70 was greater than the time for the particle 12 to cross the interaction zone 24, then some particles would cross the interaction zone 24 without being optically excited and would thus not be detected. A dichroic mirror 74 enables the time gated detector 76 to detect the fluorescent light 78 emitted by the particle 12.

Some typical operation parameters are listed in Table 1

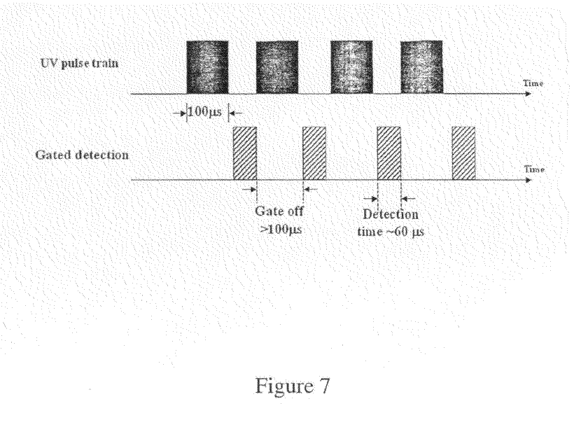

In the time gated detection depicted in FIG. 7, when the light emitting diode 34, or some other source of stimulating light, turns off, the time-gated detector 76 is triggered to detect the fluorescent light 78. While the detector 76 is on, the spatial filter 50 at the image plane is used to image a section of the flow stream that has been excited. Each successive detector 76 cycle images the next section of the flow stream so each section is imaged only once and consequently no labelled particle is missed or detected more than once. The size of the spatial filter 50 is a function of flow rate through the flow cell 16 and stimulating light 70 pulse repetition rate.

It will be appreciated that some embodiments of the invention have at least some of the following advantages:

1. some embodiments are potentially compact, miniaturised or even integrated to create a portable device;
2. the use of light emitting diodes as a source of stimulating light facilitates the manufacture of cheap embodiments suitable for many desirable applications;
3. light emitting diodes have low power consumption, allowing the development of efficient and/or portable battery powered flow cytometers;
4. light emitting diodes are very reliable, contributing to the reliability of the device as a whole;
5. in the case of using nanoencapsulated dyes and complexes, many times improvement in signal detection;
6. high target cell arrival rate (up to 10,000 target/s) when 100 kHz repetition rates are used;
7. improved excitation efficiency (up to 30 times) using a low-cost setup due to the feasibility and availability of blue/violet laser light emitting diodes; and
8. signal luminescence amplification by a theoretical factor up to 1,000 and reduced raw sample preparation.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. For example, the optoelectronics could be miniaturised and integrated, and the fluidic system replaced with a micro-fluidic system which could then be integrated with the optoelectronics, forming a lab-on-a-chip. Also, the geometry of the scattered or fluorescent light detection, or excitation, could include any one of forward, backward, side, top, bottom, or a combination or degree of these. The present embodiments are, therefore, to be considered in all respects as illustrative and not restrictive.

TABLE 1
Possible parameters and theoretical cell analysis rates in
embodiments of a time gated fluorescent flow cytometer.

| | Embodiment | One possible embodiment | |
|---|---|---|---|
| | with object of | | Long-pulsed 6 |
| | interest detector | Short-pulsed 100 kHz | kHz excitation |
| | (LED) | excitation (laser) | (LED) |
| TGL period^{1,2} | 150 μs | 10 μs | 166 μs |
| Tₑₓ + T_{TGLdelay} + T_{TGL} | (Tₑₓ = 100 μs) | (Tₑₓ < 2 μs) | (Tₑₓ = 100 μs) |
| Excitation spot | ~500 μm | 34 μm | ~500 μm |
| size Dₑₓ¹ | (Focus limit) | | (Focus limit) |
| Detection spot size^{1,2} | >34 μm | 68 μm | 599 μm |
| Dₑₘ | | | |
| Detection spot | 340 μm | 0 μm | 304 μm |
| delayed position | | | |
| D_{emdelay}^{1,3} | | | |
| Maximum cell flow | <750 cells s⁻¹ | Unlimited | Unlimited |
| rate⁴ | | | |
| Maximum target cell | <67 target cells s⁻¹ | <14,850 target cells s⁻¹ | <891 target cells s⁻¹ |
| flow rate⁵ | | | |

¹The flow velocity ν is 3.4 m s⁻¹;
²he smallest detectable pulse width (pulse width threshold) is 10 μs;
³The position at the start of excitation illumination is regarded as 0 μm;
⁴The acceptable detection efficiency >90%;
⁵The acceptable counting efficiency >99%.

1. An apparatus for detecting a particle labelled with a fluorescent marker, the apparatus comprising:
a flow cell being adapted to contain a fluid in which the particle is suspended;
a light source operatively coupled to the flow cell and arranged for emitting a stimulating light which is effective in optically exciting the fluorescent marker for emitting a fluorescent light; and
a spatial filter positioned across an optical path between the particle and a time gated detector operatively coupled to the flow cell for detecting the fluorescent light.

2. An apparatus as defined by claim 1 wherein the light source is a light emitting diode.

3. An apparatus as defined by claim 1 2 also comprising a condenser lens for collecting the stimulating light.

4. An apparatus as defined by claim 1 also comprising another spatial filter for spatially filtering the stimulating light.

5. An apparatus as defined by claim 1 also comprising a wavelength selective filter for filtering the stimulating light.

6. An apparatus as defined by claim 1 also comprising a dichroic mirror for reflecting the stimulating light.

7. An apparatus as defined by claim 1 also comprising an objective lens for focussing the stimulating light.

8. An apparatus as defined by claim 1 also comprising an objective lens for collecting the fluorescent light.

9. An apparatus as defined by claim 8 wherein the spatial filter is at an image plane of the objective lens for collecting the fluorescent light.

10. An apparatus as defined by claim 1 wherein the time gated detector is an optical band limited detector.

11. An apparatus as defined by claim 10 wherein the optical band limited detector includes an optical pass band filter for passing the fluorescent light.

12. An apparatus for detecting a particle labelled with a fluorescent marker, the apparatus comprising:
a flow cell being adapted to contain a fluid in which the particle is suspended;
a light source operatively coupled to the flow cell and arranged for emitting a stimulating light which is effective in optically exciting the fluorescent marker for emitting a fluorescent light;
an object of interest detector operatively coupled to the cell and adapted to trigger the light source; and
a time gated detector operatively coupled to the flow cell for detecting the fluorescent light.

13. An apparatus as defined by claim 12 wherein the object of interest detector is an optoelectronic object of interest detector.

14. An apparatus as defined by either of claims 12 or 13 wherein the object of interest detector includes a probe light and a scattered light detector, the probe light being arranged to interact with the object of interest creating a scattered probe light, and a scattered light detector being arranged to detect the scattered probe light for triggering a pulse from the light source.

15. An apparatus as defined by claim 14 wherein the scattered light detector is a forward scattered light detector.

16. An apparatus as defined by claim 14 wherein the scattered light detector is a side scattered light detector.

17. A method of detecting a particle labelled with a fluorescent marker, the method comprising the steps of:
passing a fluid in which the particle is suspended through an interaction zone of a flow cell;
optically exciting the fluorescent marker by periodically illuminating the interaction zone with pulses of stimulating light with the time interval between pulses being less than the time for the particle to cross the interaction zone; and
time gated detection of a fluorescent light emitted from the optically excited fluorescent marker.

18. An apparatus for detecting a particle labelled with a fluorescent marker, the apparatus comprising:
a flow cell being adapted to contain a fluid in which the particle is suspended;
a light emitting diode operatively coupled to the flow cell and arranged for emitting a stimulating light which is effective in optically exciting the fluorescent marker for emitting a fluorescent light; and
a time gated detector operatively coupled to the flow cell for detecting the fluorescent light.

19. An apparatus as defined by claim 18 wherein the light emitting diode is an ultraviolet light emitting diode.

20. An apparatus as defined by claim 19 wherein the ultraviolet light emitting diode is one of a plurality of ultraviolet light emitting diodes.

21. An apparatus as defined by any one of claims 18, 19 or 20 wherein the light emitting diode is a pulsed light emitting diode.

22. An apparatus as defined by claim 21 wherein the light emitting diode is driven by a pulsed light emitting diode current for pulsing the stimulating light.

23. An apparatus as defined by any one of claims 18, 19 or 20 wherein the light emitting diode is a laser diode.

24. An apparatus as defined by any one of claims 18, 19 or 20 wherein the time gated detector is an electronically time gated detector.

25. An apparatus as defined by claim 24 wherein the time gated detector is a solid state channel photomultiplier tube,

26. An apparatus as defined by claim 18 also comprising a current-voltage amplifier for receiving a current from the time gated detector.

27. An apparatus as defined by claim 26 wherein the apparatus includes a data acquisition circuit for receiving a voltage from the current-voltage amplifier.

28. An apparatus as defined by claim 27 wherein the apparatus includes electronics for receiving data from the data acquisition circuit.

29. A method of detecting a particle labelled with a fluorescent marker, the method comprising the steps of:
passing a fluid in which the particle is suspended through a flow cell;
optically exciting the fluorescent marker with a stimulating light from a light emitting diode for emission of a fluorescent light; and
time gated detection of the fluorescent light.

30. A method as defined by claim 29 also comprising the step of emitting the stimulating light as a pulse of stimulating light.

31. A method as defined by claim 30 wherein the step of time gated detection involves synchronising this step with the step of emitting a pulse of stimulating light.

32. A method as defined by claim 31 wherein the step of synchronising the time gated detection with the step of emitting a pulse of stimulating light involves opening the gated detector after the step of emitting the pulse of stimulating light.

33. A method as defined by any one of claims 29, 30, 31, or 32 wherein the step of time gated detection of the fluorescent light involves the step of collecting the fluorescent light.

34. A method as defined by claim 33 wherein the step of time gated detection of the fluorescent light includes the step of filtering the fluorescent light.

35. A method as defined by claim 29 wherein the step of time gated detection of the fluorescent light includes the step of limiting the coverage of the detector with respect to the flow cell.

36. A method as defined by claim 29 wherein the step of optically exciting the fluorescent marker with a stimulating light includes the step of collecting the light from the light emitting diode.

37. A method defined by claim 29 wherein the step of optically exciting the fluorescent marker with a stimulating light includes the step of filtering the stimulating light.

38. A method defined by claim 29 wherein the step of optically exciting the fluorescent marker with a stimulating light includes the step of focusing the stimulating light.

39. A method as defined by any one of claims 30, 31 or 32 wherein the step of emitting a pulse of stimulating light is triggered when an object-of-interest is detected.

40. An apparatus or method as defined by any one of claims 1, 12, 17, 18 or 29 wherein the fluorescent marker has a fluorescence lifetime greater than 100 nanoseconds.

41. A method of detecting a particle, the method comprising the steps of:
labelling the particle with a nanoencapsulated fluorescent marker;
passing a fluid in which the particle is suspended through a flow cell;
optically exciting the fluorescent marker with stimulating light from a light emitting diode for emission of a fluorescent light; and
time gated detection of the fluorescent light.

42. A method of detecting a particle as defined by claim 41 wherein the step of labelling the particle includes labelling the particle with a nanoencapsulated oxygen-quenchable dye or complex.

43. A method of detecting a particle as defined by claim 42 wherein the step of labelling the particle includes the step of labelling the particle with nanoencapsulated phosphorous, platinum, ruthenium, osmium or rhenium dye or complex.

44. A method of detecting a particle as defined by any one of the claims 41, 42, or 43 wherein the step of optically exciting the fluorescent marker with stimulating light includes the step of generating blue and/or violet light from the light emitting diode.

45. A method of detecting a particle as defined by claim 44 wherein the step of generating blue and/or violet light includes the step of pulsing the light emitting diode.

46. A method of detecting a particle as defined by any one of the claims 41, 42 or 43 wherein the light emitting diode is a laser light emitting diode.
